(19) United States
(12) Patent Application Publication
(10) Pub. No.: US 2011/0159400 A1
(43) Pub. Date: Jun. 30, 2011

(54) Hybrid Catalyst System and Electrode Assembly Employing the Same

(75) Inventor: Mohan Karulkar, Dearborn, MI (US)

(73) Assignee: FORD GLOBAL TECHNOLOGIES, LLC, Dearborn, MI (US)

(21) Appl. No.: 12/715,549

(22) Filed: Mar. 2, 2010

(51) Int. Cl. H01M 4/92; B01J 21/18; H01M 4/02; H01M 8/10

(52) U.S. Cl. 429/483; 502/185; 429/523; 429/524; 429/492

(57) ABSTRACT

According to one aspect of the present invention, a hybrid catalyst system is provided. In one embodiment, the hybrid catalyst system includes a support mixture and a catalyst material supported on the support mixture, wherein the support mixture includes a first support material having a first average surface area and a second support material having a second average surface area different from the first average surface area, the first and second support materials collectively defining regions of differential hydrophobicity. In certain instances, the hybrid catalyst system can be configured as a catalyst layer to be disposed next to a proton exchange membrane of a fuel cell.

### BACKGROUND

1. Technical Field

One or more embodiments of the present invention relate to a hybrid catalyst system and an electrode assembly employing the same.

2. Background Art

A fuel cell generally includes two electrodes, an anode and a cathode, separated by an electrolyte. The electrodes are electrically connected through an external circuit, with a resistance load lying in between them. Solid polymer electrochemical fuel cells in particular employ a membrane electrode assembly (MEA) containing a solid polymer electrolyte membrane (PEM), also known as a proton exchange membrane, in contact with the two electrodes.

Polymer Electrolyte Membrane (PEM) fuel cells require certain water balance to provide efficient performance, including relatively high proton mobility and low occurrence of flooding. For instance, excess water can lead to flooding and hence reduced oxygen diffusion at the surface of the catalyst coated membrane (CCM). Excess water can also contribute to carbon corrosion in the catalyst. On the other side of the spectrum, insufficient water can cause drying of the catalyst layer, which may lead to slow start-up times, poor conductivity in the CCM, shortened membrane life, and/or overall performance loss.

### SUMMARY

According to at least one aspect of the present invention, a hybrid catalyst system is provided. In one embodiment, the hybrid catalyst system includes a support mixture and a catalyst material supported on the support mixture, wherein the support mixture includes a first support material having a first average surface area and a second support material having a second average surface area different from the first average surface area, the first and second support materials collectively defining regions of differential hydrophobicity. In certain instances, the hybrid catalyst system can be configured as a catalyst layer to be disposed next to a proton exchange membrane of a fuel cell.

In another embodiment, the regions of differential hydrophobicity include a relatively hydrophilic channel for passing water molecules and a relatively hydrophobic channel for passing oxygen molecules.

In yet another embodiment, the catalyst material includes a first noble metal catalyst supported on the first support material and a second noble metal catalyst supported on the second support material.

In yet another embodiment, the first and second support materials both include carbon black.

In yet another embodiment, the first material surface area of the first support material containing carbon black is from 300 to 2300 square meters per gram (m²/g). In yet another embodiment, the second material surface area of the second support material containing carbon black is from 10 to 900 square meters per gram (m²/g).

In yet another embodiment, the first and the second noble metal catalysts each independently include a noble metal, a metallic alloy having at least one noble metal, or combinations thereof. In yet another embodiment, one of the first and second noble metal catalysts includes platinum and the other includes a metallic alloy of platinum, nickel, and cobalt.

According to another aspect of the present invention, an electrode assembly is provided for use in a fuel cell. In one embodiment, the electrode assembly is configured as a membrane electrode assembly including a proton exchange membrane and a catalyst layer, as described herein, disposed next to the proton exchange membrane. In another embodiment, the electrode assembly is configured as a gas diffusion electrode including a gas diffusion layer and a catalyst layer, as described herein, disposed next to the gas diffusion substrate.

According to yet another aspect of the present invention, a fuel cell is provided. In one embodiment, the fuel cell includes a membrane electrode assembly described herein.

### BRIEF DESCRIPTION OF THE DRAWINGS

FIG. 1 depicts a schematic cross-section view of a membrane electrode assembly according to one aspect of the present invention;

FIG. 2 depicts an enlarged top view of a portion of the catalyst layer of FIG. 1, wherein the portion contains regions of differential affinity for molecules such as water and oxygen;

FIG. 3 depicts a plot of potential as a function of current density compared among three different catalyst formulations according to the example described herein;

FIG. 4 depicts a plot of potential as a function of current density compared among three different catalyst formulations that have been subjected to 10,000 potential cycles according to the example described herein;

FIG. 5a depicts a plot of potential as a function of current density of a catalyst sample “D50” before and after the 10,000 potential cycles according to the example described herein;

FIG. 5b depicts a plot of potential as a function of current density of a catalyst sample “D50-H50” before and after the 10,000 potential cycles according to the example described herein;

FIG. 5c depicts a plot of potential as a function of current density of a catalyst sample “D50-H27” before and after the 10,000 potential cycles according to the example described herein;

FIG. 6a depicts normalized ECA compared among different catalyst samples before and after 10,000 potential cycles according to the example described herein;

FIG. 6b depicts absolute/raw ECA compared among different catalyst samples before and after 10,000 potential cycles according to the example described herein; and

FIG. 7 depicts an exemplary fuel cell.

### DETAILED DESCRIPTION

Reference will now be made in detail to compositions, embodiments, and methods of the present invention known to the inventors. However, it should be understood that disclosed embodiments are merely exemplary of the present invention which may be embodied in various and alternative forms. Therefore, specific details disclosed herein are not to be interpreted as limiting, rather merely as representative bases for teaching one skilled in the art to variously employ the present invention.

Except where expressly indicated, all numerical quantities in this description indicating amounts of material or conditions of reaction and/or use are to be understood as modified by the word “about” in describing the broadest scope of the present invention.

The description of a group or class of materials as suitable for a given purpose in connection with one or more embodiments of the present invention implies that mixtures of any two or more of the members of the group or class are suitable. Description of constituents in chemical terms refers to the constituents at the time of addition to any combination specified in the description, and does not necessarily preclude chemical interactions among constituents of the mixture once mixed. The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

As a component to a fuel cell adapted for use in a mobile vehicle, catalysts for both the anode and cathode electrodes have been increasingly investigated in automobile research and development for improved cell power generation.

Operation of fuel cells is often confronted with technical difficulties and challenges. For instance, inadequate water management at the cathode may cause flooding, a situation that may worsen in response to various parameters. Some of the parameters include increased electrode thickness, decreased proton transport, and uncoupled water removal. In particular situations, cathode flooding occurs when water production at the oxygen reduction reaction and electro-osmotic drag of water to the cathode exceed the water removal rate resulting from air based advection, evaporation, and/or back diffusion. Liquid water that builds up at a fuel cell cathode decreases performance and inhibits robust operation. Flooding in the cathode reduces oxygen transport to reaction sites and decreases the effective catalyst area. Cathode flooding can result in a significant decrease of performance.

Therefore, water management is an important issue concerning the long-term viability of proton exchange membrane fuel cells (PEMFCs) for application in the automobile industry. Fuel cells such as PEMFCs require a balanced water content to provide efficient performance including improved proton mobility and reduced flooding. Excess water can lead to flooding at the surface of the catalyst coated membrane (CCM) and prevent oxygen diffusion to the CCM surface. Insufficient water can cause drying of the catalyst layer, leading to slow start-up times, poor conductivity in the membrane, shortened membrane life, and overall performance loss.

It has been discovered that a hybrid catalyst system provided according to certain embodiments of the present invention, can be configured as a catalyst layer and used in a fuel cell to enhance electrochemical performance of the fuel cell with relative low ECA loss, wherein ECA stands for electrochemical catalytic area. Without being limited to any particular theory, one possible explanation for the improved electrochemical performance realized with the use of the hybrid catalyst system according to one or more embodiments of the present invention is due to the effective control of water management in the fuel cell, particularly at the fuel cell membrane surface. It has further been found that water balance in an electrochemical device including a fuel cell can be effectively managed by strategically providing regions of differential hydrophobicity in the hybrid catalyst system and the electrode assembly employing the same according to certain other embodiments of the present invention.

According to one or more embodiments of the present invention, the term “differential hydrophobicity” may refer to first and second regions of the hybrid catalyst system, in which the first regions have a relatively higher affinity for molecules such as water and thus facilitate transport of the water molecules, and the second regions have a relatively higher affinity for molecules such as oxygen and thus facilitate transport of oxygen molecules. As a result, flow of water and flow of oxygen in a fuel cell compartment can be managed and flooding can be effectively controlled.

For the purpose of illustration, an exemplary fuel cell 720 is schematically depicted in FIG. 7. The fuel cell 720 includes a pair of bi-polar plates 722 and 724 having grooves 726 and 728 formed at a predetermined interval on both sides of each of the bi-polar plates 722 and 724. The fuel cell 720 also includes a proton exchange membrane 734 disposed between the bi-polar plates 722 and 724, a first electrode such as an air electrode 732 disposed between the proton exchange membrane 734 and the bi-polar plate 724, and a second electrode such as a fuel electrode 730 disposed between the proton exchange membrane 734 and the bi-polar plate 722.

The bi-polar plates 722 and 724 are for electrically connecting the air electrode 732 and the fuel electrode 730, and preventing fuel and air (an oxidizer) from being mixed. The grooves 726 and 728 are used as fuel and air passages in the cells connected end to end.

In operation, air is brought into contact with the air electrode 732, while at the same time hydrogen gas is brought into contact with the fuel electrode 730 as fuel, which results in separation of the hydrogen gas into hydrogen ions and electrons on the fuel electrode 730. These hydrogen ions are combined with water to move to the air electrode 732 side in the proton exchange membrane 734, while the electrons move via on external circuit (not shown) to the air electrode 732 side. In the air electrode 732, oxygen, electrons, and hydrogen ions react to generate water.

According to one aspect of the present invention, and as depicted in FIG. 2, an electrode assembly generally shown at 100 is provided for use in an electrochemical device such as a fuel cell of FIG. 7. The electrode assembly 100 can be used as a fuel electrode such as the fuel electrode 730 of FIG. 7 or used as an air electrode such as the air electrode 732 of FIG. 7. For illustration purposes, the electrode assembly 100 includes a substrate 104 such as a proton exchange membrane, a catalyst layer 102 as a cathode formed from a hybrid catalyst system which will be described in more detail herein, and anode 106. Of course, the anode 100 can also be formed of the hybrid catalyst system if needed.

Although some of the embodiments described herein are directed to a one layer configuration, it is still within the spirit of the present invention to configure the catalyst layer 102 to include two or more catalyst layers and/or to have each of the layers include one or more sub-layers.

As depicted in FIG. 2, a portion of the catalyst layer 102 in an enlarged view is shown to have regions 202 and 204 with differential hydrophobicity such that the catalyst system provides a synergistic enhancement in tolerance to water accumulation and improvement in cost efficiency. In one embodiment, the hybrid catalyst system includes a support mixture and a catalyst material supported on the support mixture, wherein the support mixture includes a first support material having a first average surface area and a second support material having a second average surface area different from the first average surface area, and wherein the first and second support materials collectively defining regions of differential hydrophobicity. The first and second material surface areas can be calculated based on the BET (Brunauer Emmett Teller) theory or method.

In another embodiment, the regions of differential hydrophobicity include first regions 202 configured as a relatively hydrophilic channel for passing water molecules and second regions 204 configured as a relatively hydrophobic channel for passing oxygen molecules.

In yet another embodiment, the catalyst material includes a first noble metal catalyst supported on the first support material and a second noble metal catalyst supported on the second support material.

In yet another embodiment, the first average surface area of the first support material, optionally containing carbon black, is between 300 m²/g to 2,300 m²/g, 600 m²/g to 2,300 m²/g, or 900 m²/g to 2300 m²/g (square meters per gram) dry weight of the first support material.

In yet another embodiment, the second average surface area of the second support material, optionally containing carbon black, is between 10 m²/g to 900 m²/g, 10 m²/g to 600 m²/g, or 10 m²/g to 300 m²/g (square meters per gram) dry weight of the first support material.

It has also been found the catalyst layer 102 according to certain embodiments of the present invention, when used in a fuel cell application, is configured to increase voltage-current performance and reduce ECA loss of the fuel cell. Therefore, the instant catalyst according to one or more embodiments of the present invention is further defined over conventional catalysts with catalyst metals supported on a material having uniform surface area, enables a relatively higher fuel cell performance.

As used herein in one or more embodiments, the term “current density” may refer to an amount of electric current in unit of ampere(s) per square centimeter of a planar surface of the fuel cell in which the catalyst is adapted to be used. An example of the planar surface includes the air electrode 732 and the fuel electrode 730 as depicted in FIG. 7.

The hybrid catalyst system as described herein can take many different forms depending on various types of applications at hand. For instance, the catalyst assembly can take the form of a catalyst layer, a catalyst column, a catalyst ball, and a catalyst cube. The followings embodiments directed to the catalyst assembly are described within the context of a catalyst layer. However, it should be noted that an actual form of the catalyst assembly is not limited to a catalyst layer and can be of any suitable form illustrated above.

The first and the second support materials may each independently include one or more of the following materials: carbon, such as carbon black of various particles sizes, mesoporous carbons and carbon gels; carbides formed of carbon and a less electronegative element; and inorganic metal oxides, such as titanium-based oxides, tin-based oxides, tunsgen-based oxides, ruthenium-based oxides, zirconia-based oxides, silicon-based oxides, indium tin-based oxides. An article by E. Antolini and E. R. Gonzalez, entitled “Ceramic materials as supports for low-temperature fuel cell catalysts,” published in Solid State Ionics 180 (2009) 746-763 provides a list of support materials that can be used in accordance with one or more embodiments of the present invention. The entire contents of this article are incorporated herein by reference.

In certain embodiments, the first and the second support materials each independently include carbon black. When used as the support material, carbon black can be configured to have different surface area and hence differential hydrophobicity for use in a fuel cell environment. Carbon blacks can be configured to have various particles sizes, with relatively bigger particles sizes per a given weight generally indicating a relatively lower surface area. However, surface area measurements can be carried out using any suitable method. One method is pursuant to the BET theory.

By way of example, carbon black by the trade name of “Ketjenblack EC” can have a relatively high surface area value in the range of 800 to 1000 square meters per gram, or m²/g; whereas carbon black by the trade name of “Acetylene black” can have a relatively low surface area value in the range of 50 to 100 m²/g. A list of carbon blacks with corresponding surface area value is tabulated in Table 1.

TABLE 1
An illustrative list of carbon black materials
having various surface area

| Carbon Black | Average Surface Area |
|---|---|
| Material | (m²/g) |
| Black Pearls 2000 | 1500 |
| Ketjenblack EC | 930 |
| Vulcan XC-72 | 250 |
| Spheron C | 230 |
| Vulcan XC-72 | 180 |
| Ketjenblack HAF | 110 |
| Acetylene black | 65 |

In certain particular embodiments, the hybrid catalyst system includes catalyst metals such as platinum supported on a relatively high surface area carbon backing and catalyst metals such as platinum supported on a relatively low surface area carbon backing to introduce regions of differential hydrophobicity and hence differential affinity for water or oxygen molecules. It is believed that regions represented by the relatively low surface area carbon backing are relatively hydrophilic, while regions represented by the relatively higher surface area carbon backing are relatively hydrophobic. As a result of this arrangement, and as indicated herein elsewhere, special pathways are formed within the hybrid catalyst system that particularly favor water transport. The localized gradients created regions of varying wetness within the catalyst layer, allowing relatively more hydrophobic or relatively less hydrophilic pathway(s) for oxygen to diffuse, and generating relatively less hydrophobic or relatively more hydrophilic pathway(s) for water to exit. This is in contrast to a traditional catalyst system, which has homogenous hydrophobicity properties and wherein oxygen diffusion or water exit cannot be accommodated effectively. The use of mixed carbon, for instance, represents a novel approach to creating regions of differential hydrophobicity within the catalyst layer.

While the electrode assembly 100 such as a membrane electrode assembly is discussed herein in the context of a proton exchange membrane fuel cell, the scope of the invention is not so limited. Rather, the membrane electrode assemblies with catalyst layers of the present invention can be used for improved power per dollar return in any electrochemical cell requiring a catalyst layer on the surface of an electrode. For instance, the membrane electrode assemblies with catalyst layers can be utilized in electrocatalytic oxidation (ECO) cells. ECO cells utilize the typical structure of a standard proton exchange membrane fuel cell, but act as a system to remove excess carbon monoxide (CO) from the fuel cell feed stream.

The noble metal used in the first and the second noble metal catalysts illustratively includes platinum (Pt), ruthenium (Ru), palladium (Pd), rhodium (Rh), iridium (Ir), gold (Au), silver (Ag), alloys thereof, or combinations thereof. The first and the second noble metal catalysts can also include metallic alloys containing one or more noble metals. The metallic alloys may take the form of binary, ternary, or quaternary alloys. The non-noble metal alloy elements, when used in the metallic alloys, can include but not restricted to Groups IIIb, IVb, Vb, VIIb, VIIb, VIIIb, IXb, Xb, and X1b, with illustrative examples including cobalt (Co), chromium (Cr), tin (Sn), tungsten (W), iron (Fe), nickel (Ni), thorium (Th), aluminum (Al), iridium (Ir), rhodium (Rh), gold (Au), ruthenium (Ru), copper (Cu), manganese (Mn), lead (Pb), molybdenum (Mo), and palladium (Pd).

The metallic alloy according to one or more embodiments of the present invention refers to a mixture of metals wherein at least one component metal presents crystal structure that differs from respective original structure of the metal in its pure metal form.

Any suitable methods may be employed to construct the catalyst layer 102 without having to deviate from the general spirit of the present invention. For instance, the catalyst layer 102 can be applied directly on the membrane 104 by decal method to form a catalyst coated membrane (CCM). Catalyst ink is coated on a smooth surface, such as Kapton or Teflon film by doctor-blading, air brushing, screen printing, and/or deskjet/laser printing. When the catalyst layer 102 is configured to be formed of two or more catalyst sub-layers, the layers can be applied in series, applying the first layer and repeating the steps for the second layer. Different coating processes can also be utilized to form multiple layers, such as first layer can be applied by screen printing and second layer applied by air brushing.

Alternatively, the catalyst layer 102 or the catalyst sub-layers forming the catalyst layer 102 can also be applied directly on the gas diffusion layer substrate by decal method to form a catalyst coated substrate (CCS). Catalyst ink is coated on a smooth surface, such as Kapton or Teflon film by doctor-blading, air brushing, screen printing, and/or deskjet/laser printing. When applicable, the catalyst sub-layers can be applied in 2-step in series, applying the first layer and then repeating the steps for the second layer. Different coating processes can also be utilized to form multiple layers, such as first layer can be applied by screen printing and second layer applied by air brushing.

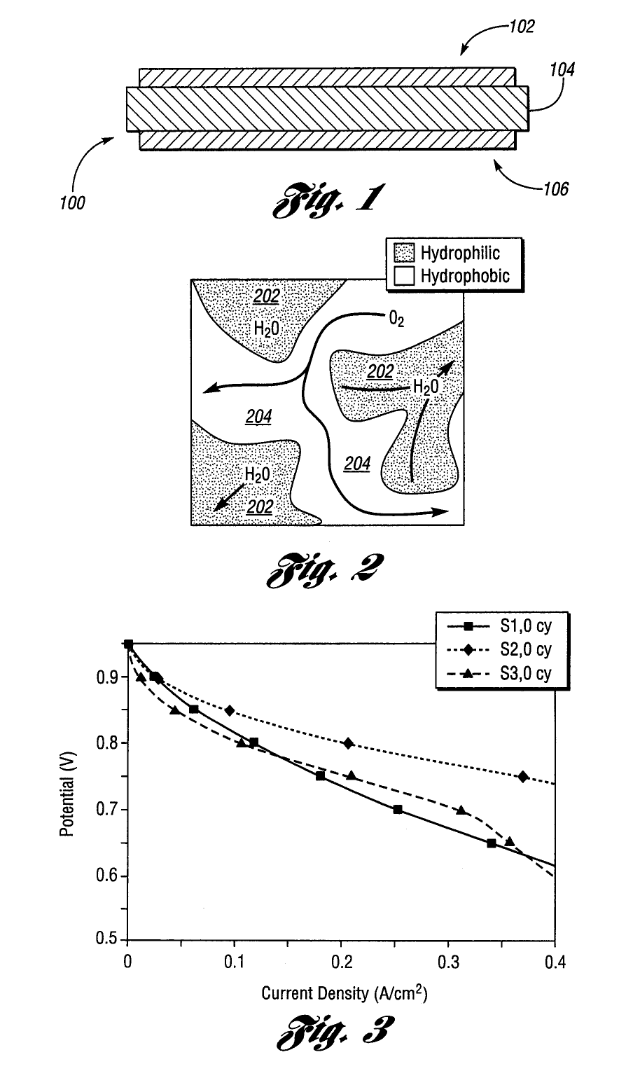

The proton exchange membrane 104 as depicted in FIG. 1 may be sulfonic acid group-containing polystyrenic cation exchange membranes used as cationic conductive membranes, and fluorine-containing ion exchange resin membranes, typically membranes made of a mixture of a fluorocarbonsulfonic acid and polyvinylidene fluoride, membranes produced by grafting trifluoroethylene onto a fluorocarbon matrix, and perfluorosulfonic acid resin membranes. An illustrative example for the solid polyelectrolyte membrane is Nafion® membranes made by DuPont.

Having generally described this invention, a further understanding can be obtained by reference to certain specific examples which are provided herein for purposes of illustration only and are not intended to be limiting unless otherwise specified.

### Example

As used in the examples, three CCM samples are provided with the same anode composition, which includes Pt on high surface area (SA) carbon. The anode is prepared by suspending Pt/C (Cabot Corp, Dynalyst 50K R1 50% Pt on High SA Ketjenblack) in dionized water and combining with Nafion and Teflon solutions.

The CCM samples vary in their respective cathode compositions. Cathode of sample S1 includes Pt on high SA carbon; cathode of sample S2 includes a hybrid mix of Pt on high SA carbon and PtNiCo on low SA carbon; and cathode of sample S3 includes a low-loading hybrid mix of Pt on high SA carbon and PtNiCo low SA carbon. The cathodes are prepared as follows. For Pt on high SA carbon as used in sample S1, catalyst ink is prepared by suspending Pt/C (Cabot Corp, Dynalyst 50K R1 50% Pt on High SA Ketjenblack) in dionized water and combining with Nafion and Teflon solutions. For the hybrid mix of Pt on high and low SA carbon as used in sample S2, catalyst ink is prepared by suspending Pt/C (Cabot Corp, Dynalyst 50K R1 50% Pt on High SA Ketjenblack) and PtNiCo/C (Cabot Corp, 50%, on Vulcan XC73). For the low-loading hybrid mix of Pt on high and low SA carbon as used in sample S3, catalyst ink is prepared by suspending Pt/C (Cabot Corp, Dynalyst 50K R1 50% Pt on High SA Ketjenblack) and PtNiCo/C (Cabot Corp, 27%, on Vulcan XC73). Pt loading on the cathode for sample S3 is 22% less than the Pt loading for sample S1 or S2.

For a 55 mg catalyst sample, for the anode or the cathode, suspended in 60 ml water, 24 drops (0.3 ml) of ElectroChem Inc. Nafion 5% Solution (EC-NS-05-AQ) and 2 drops (0.025 ml) of ElectroChem. Inc. Teflon Emulsion Solution (EC-TFE-500 ml) are added. 4 drops (0.05 ml) of Al(NO₃)₃ are also added to the ink solution, leading to slight agglomeration, which is believed to aid in filtration/drainage. The solution is mixed via ultrasonic bath for 2 minutes after each component is added.

The anode and cathode catalyst inks are filtered through Crepe Exam Table Paper using 24 cm² Buchner funnels. No vacuum is applied, and filtration/drainage takes 1.5 hours. After drainage is complete, a moist layer of catalyst slurry is left on the crepe papers, approximately 1 mm thick. The filter papers are carefully removed and applied to either side of a 16 in² piece of Nafion(111) which has been soaked in 50° C. water for 1.5 hours. The crepe paper and Nafion assembly is then pressed (Carver Hot Press, Model 4122) at 170° F., with a force of 120 lbs for 1.5 minutes and then 150 lbs for 30 seconds. The assembly is then cooled to room temperature in the press, with 150 lbs force being maintained. After cooling, the assembly is removed from the press and the crepe paper backings are peeled away, leaving the anode and cathode catalyst layers pressed onto the Nafion. The CCM samples are then pressed between two sheets of 0.005 inch Teflon at 270° F. and 1800 lbs for 15 minutes. The CCM is then cooled in the press, with 1800 lbs pressure maintained. Upon cooling, the CCM is stored in a sealed bag for later use.

A fuel cell test stand is used to test the CCM samples in 50 cm² testing cells. Ultra high purity hydrogen gas is used for anode fuel, and air from the house supply is used for the cathode fuel. The cells, gas humidifier, and gas lines are held between 65° F. and 70° F. The CCM samples undergo a “break-in” period once installed in the testing cell, during which time the current is monitored until a constant value is reached. One cycle of the break-in procedure consists of a 0.3V constant voltage for 10 minutes, followed by a 1V spike for 3 seconds. Break-in typically took 1-3 days, and is considered complete when the current at 0.3V leveled off.

After break-in, performance measurements are taken by applying potential in a stepwise fashion from 0.3 to 0.95V, allowing the current to stabilize at each step for 5 minutes, and noting the current. A LabView program is written to monitor the potential and current response of the cell during break-in and performance testing.

After performance measurements are taken, the test cell is connected to a Solartron 1480 Multistat potentiostat and subjected to potential cycling to approximate accelerated usage. H₂ is fed to the anode and used as the reference electrode, while N₂ is fed to the cathode. Potential is cycled between 0.35V and 1.2V, for 15s at each point. After the potential cycling procedure, a cyclic voltagram (CV) is taken (10 mV/s scan rate, 0.08V-1.0V) in order to measure ECA loss. CorrWare is used to manage the voltage cycling and CV procedures and to record data. After obtaining a CV measurement, air is reconnected to the cathode and the cell undergoes re-break-in and post-corrosion performance measurements. Performance and ECA-loss measurements are obtained for 0, 4000, and 10000 potential cycles.

TABLE 2
Composition Summary of the CCM Samples

| | Cathode | | | |
|---|---|---|---|---|
| Sample | component 1 | component 2 | Pt loading | Anode |
| S1 | High SA | n/a | 2.73 mg/cm² | High SA |
| | Pt/C | | | Pt/C |
| S2 | High SA | Low SA | 1.36 mg/cm² | High SA |
| | Pt/C | PtNiCo/C | per component | Pt/C |
| S3 | High SA | Low SA | 1.06 mg/cm² | High SA |
| | Pt/C | PtNiCo/C | per component | Pt/C |

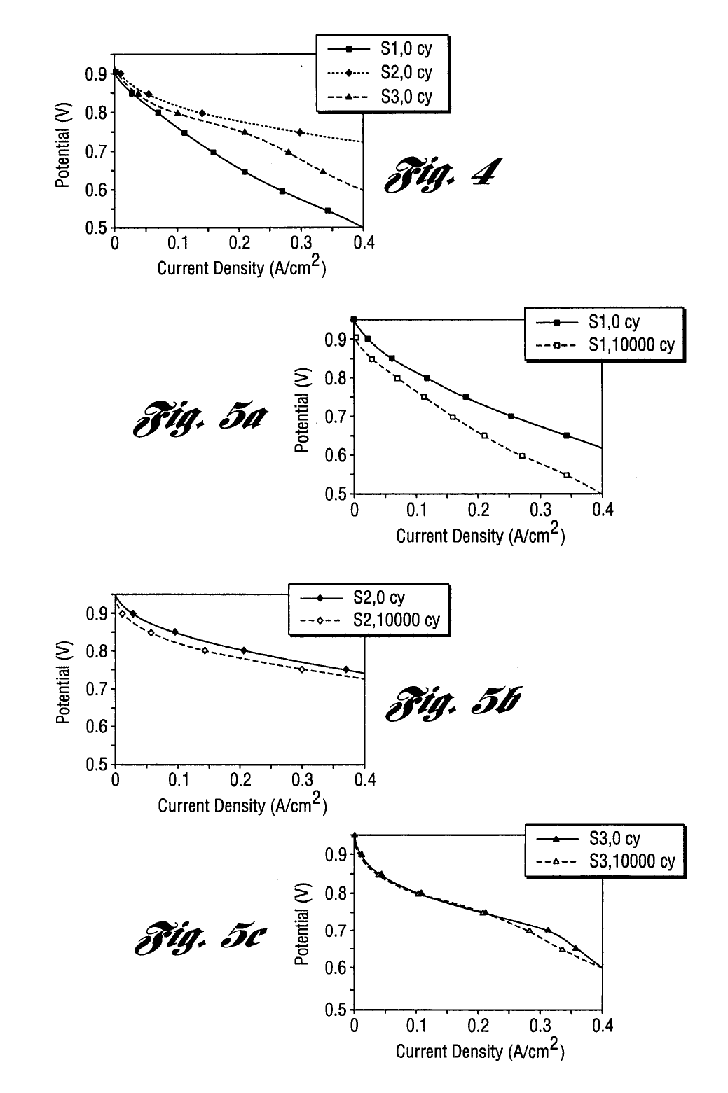

FIG. 3 shows results of beginning-of-life (BOL) performance measurements on the three CCM samples indicated in Table 2. For current densities up to 0.4 A/cm², sample S2 outperforms baseline sample S1, despite both catalysts having the same total Pt loading. In fact, sample S2's outperformance continues at higher current densities as well, where mass transport is a governing factor. Sample S3 which has a 22% lower cathode Pt loading, displays a similar performance as the higher-loading baseline sample S1.

FIG. 4 shows performance results for the three CCM samples after 10,000 potential cycles. Both hybrid catalysts show better performance after corrosion than the baseline sample S1. Whereas sample S3 is about equal with the baseline sample S1 at 0 cycles, sample S3 surpasses the performance of the baseline sample S1 after corrosion. The performance trend continues into the mass-transport region as well.

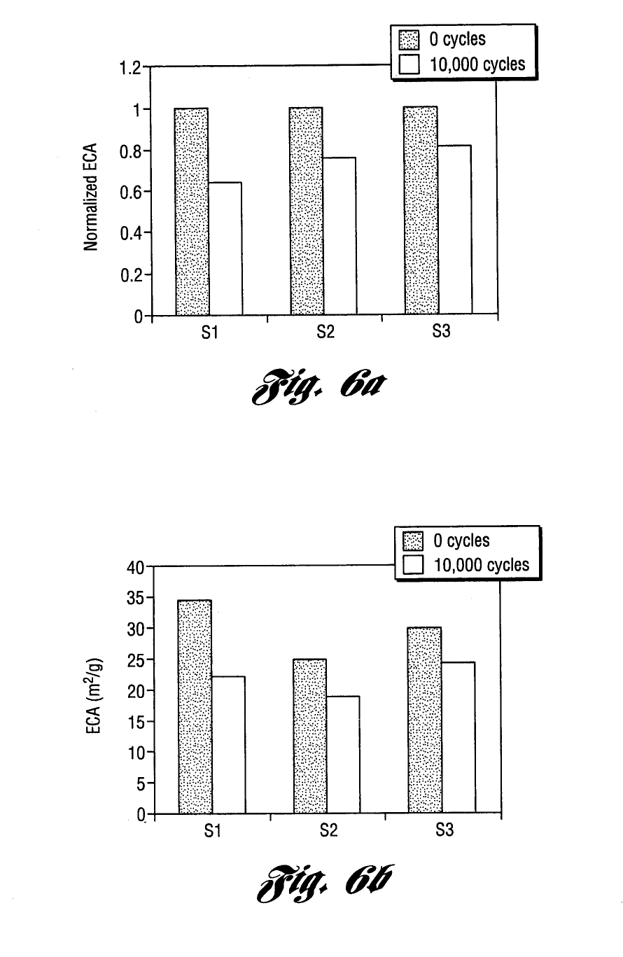

FIGS. 5a-5c respectively reveal the amount of performance loss for each CCM samples after 10000 potential cycles. The CCM samples S2 and S3 elicit less performance loss than the baseline sample S1. The sample S3 shows almost no performance loss below 0.25 A/cm². The baseline sample S1, one the other hand, shows larger performance loss, which increases with the current density applied.

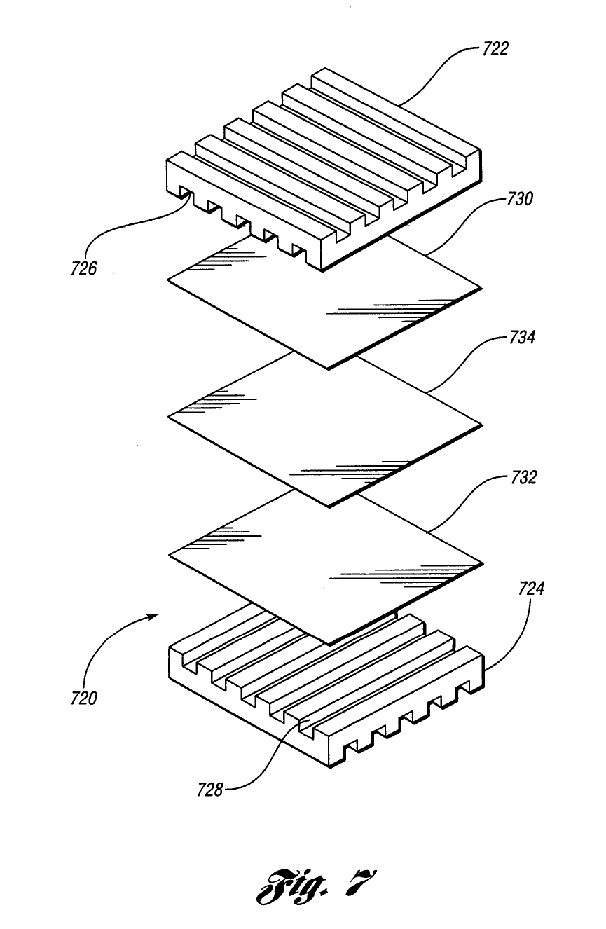

FIGS. 6a and 6b respectively show normalized and raw ECA for the three CCM samples, at 0 and 10,000 potential cycles. ECA loss is greatest for the baseline sample S1, at about 40% loss. Sample S3 has the lowest ECA loss of 20%, while sample S2 elicits a loss of about 25%. It can be seen that the baseline sample S1 has the highest starting ECA (a consequence of having purely high-SA carbon backing), while sample S3 has the highest ECA after potential cycling.

As can be seen from FIGS. 3, 4, 5a-5c, and 6a-6b, samples S2 and S3 consistently demonstrate the reduced ECA loss after 10,000 potential cycles normalized to the starting point at 0 (zero) cycles. Without being limited to any particular theory, the reduced ECA loss observed with samples S2 and S3 is believed to be due to the improved water management in the hybrid catalyst materials present in the samples S2 and S3. Sample S3, which performs comparatively with the baseline sample S2 despite having a lower Pt loading, contains more low-SA carbon backing than does sample S2. The results indicate an optimum balance of low- and high-SA carbon backing, which lies somewhere between sample S2 and sample S3. Because sample S3 suffers so little ECA loss, it may be possible to conclude that the optimal hybrid mixing would include more low-SA carbon than high-SA carbon. Carbon corrosion, which hinges on the presence of excess water in the catalyst layer, is a key component to performance and ECA loss. If sample S3 has superior water management properties, the low performance loss and ECA loss is understandable. The lower performance of sample S3 as compared to sample S2 can be explained by the lower Pt loading in sample S3 relative to sample S2.

The data suggests that introducing regions of differential hydrophobicity into the catalyst layer is an effective method for enhanced electrochemical performance with relatively reduced ECA loss, possibly via efficient water management. Further optimization is possible, as evidenced by the equal-or-better performance of sample S3 over the baseline, and superior corrosion resistance of sample S3 over sample S2. Adjustment of the low-to-high SA carbon backing ratio and Pt loading will likely have a positive effect on the performance of the mixed-carbon backing hybrid catalysts.

While the best mode for carrying out the invention has been described in detail, those familiar with the art to which this invention relates will recognize various alternative designs and embodiments for practicing the invention as defined by the following claims.

What is claimed:

1. A hybrid catalyst system comprising:
a support mixture including a first support material having a first average surface area and a second support material having a second average surface area different from the first average surface area, the first and second support materials collectively defining regions of differential hydrophobicity; and
a catalyst material supported on the support mixture.

2. The hybrid catalyst system of claim 1, wherein the regions of differential hydrophobicity include a relatively hydrophilic channel for passing water molecules and a relatively hydrophobic channel for passing oxygen molecules.

3. The hybrid catalyst system of claim 1 configured as a catalyst layer to be disposed next to a proton exchange membrane (PEM) in a fuel cell.

4. The hybrid catalyst system of claim 1, wherein the first and second support materials both include carbon black.

5. The hybrid catalyst system of claim 4, wherein the first material surface area of the first support material containing carbon black is from 300 to 2,300 square meters per gram (m²/g).

6. The hybrid catalyst system of claim 5, wherein the second material surface area of the second support material containing carbon black is from 10 to 900 square meters per gram (m²/g).

7. The hybrid catalyst system of claim 1, wherein the catalyst material includes a first noble metal catalyst supported on the first support material and a second noble metal catalyst supported on the second support material.

8. The hybrid catalyst system of claim 7, wherein the first and the second noble metal catalysts each independently include a noble metal, a metallic alloy having at least one noble metal, or combinations thereof.

9. The hybrid catalyst system of claim 8, wherein the noble metal is platinum and the metallic alloy is a metallic alloy of platinum, nickel, and cobalt.

10. An electrode assembly for use in a fuel cell, comprising:
a substrate; and
a catalyst layer disposed next to the substrate, the catalyst layer including a first noble metal catalyst supported on a first support material having a first average surface area; and a second noble metal catalyst supported on a second support material having a second average surface area different from the first average surface area, the first and second support materials collectively defining regions of differential hydrophobicity, wherein the first and second material surface areas are based on the BET (Brunauer Emmett Teller) theory.

11. The electrode assembly of claim 10, wherein the regions of differential hydrophobicity include a relatively hydrophilic channel for passing water molecules and a relatively hydrophobic channel for passing oxygen molecules.

12. The electrode assembly of claim 10 for use as a membrane electrode assembly (MEA), wherein the substrate is a proton exchange membrane (PEM).

13. The electrode assembly of claim 10 for use as a gas diffusion electrode (GDE), wherein the substrate is a gas diffusion layer (GDL).

14. The electrode assembly of claim 10, wherein the first and second support materials of the catalyst layer both include carbon black.

15. The electrode assembly of claim 14, wherein the first material surface area of the first support material containing carbon black is from 300 to 2,300 square meters per gram (m²/g), and wherein second material surface area of the second support material containing carbon black is from 10 to 900 square meters per gram (m²/g).

16. The electrode assembly of claim 10, wherein the first and the second noble metal catalysts each independently include a noble metal, a metallic alloy having at least one noble metal, or combinations thereof.

17. The electrode assembly of claim 16, wherein one of the first and second noble metal catalysts includes platinum and the other includes a metallic alloy of platinum, cobalt, and nickel.

18. A fuel cell comprising:
a proton exchange membrane; and
a catalyst layer disposed next to the proton exchange membrane, the catalyst layer containing a support mixture and a catalyst material supported on the support mixture, the support mixture including a first support material having a first average surface area and a second support material having a second average surface area different from the first average surface area, the first and second support materials collectively defining regions of differential hydrophobicity.

19. The fuel cell of claim 18, wherein the first and second support materials of the catalyst layer both include carbon black, wherein the first material surface area of the first support material containing carbon black is from 300 to 2,300 square meters per gram (m²/g), and wherein the second material surface area of the second support material containing carbon black is from 10 to 900 square meters per gram (m²/g).

20. The fuel cell of claim 19, wherein the first noble metal catalyst includes platinum and the second noble metal catalyst includes a metallic alloy of platinum, nickel, and cobalt.
